(19) United States
(12) Patent Application Publication
(10) Pub. No.: US 2011/0199752 A1
(43) Pub. Date: Aug. 18, 2011

(54) MOUNT FOR MOUNTING AN ELECTRICAL APPLIANCE, STAND COMPRISING THE MOUNT AND TOOLKIT

(75) Inventors: Tim Kern, Singapore (SG); Wee Guan Tan, Singapore (SG)

(73) Assignee: KONINKLIJKE PHILIPS ELECTRONICS N.V., EINDHOVEN (NL)

(21) Appl. No.: 13/119,802

(22) PCT Filed: Sep. 17, 2009
(86) PCT No.: PCT/IB09/54078

§ 371 Date: Mar. 18, 2011

(30) Foreign Application Priority Data
Sep. 25, 2008 (EP) 08165155.6

(51) Int. Cl. H02B 1/01; F16M 13/02; F16M 11/06; B23P 11/00

(52) U.S. Cl. 361/825; 248/220.21; 248/224.8; 248/125.7; 29/525.08

(57) ABSTRACT

The invention relates to a mount (10; 12; 14) for mounting an electrical appliance (20). The invention also relates to a stand comprising the mount, to fastening means (60) for an electrical appliance, to an electrical appliance comprising the fastening means, to a toolkit (200) for mounting the electrical appliance, and to a method of mounting the electrical appliance. The mount comprises a base (30; 32; 34) which comprises connecting means (50) for connecting the base (30; 32; 34) to a surface (100) or for connecting the base to a stand. The base is configured for distributing a weight of the electrical appliance across a part of the surface or to the stand. The base further comprises mounting means (40) extending from the base, in which the mounting means are arranged for engaging with corresponding fastening means (60) of the electrical appliance for mounting the electrical appliance substantially parallel to the base while allowing the electrical appliance (20) to be tilted around an tilting axis (70) being substantially perpendicular to the base. The effect of the mount according to the invention is that any misalignment of the mount may be corrected via tilting the electrical appliance. As such, the mounting of the electrical appliance to the surface or wall may be simplified.

### FIELD OF THE INVENTION

The invention relates to a mount for mounting an electrical appliance.

The invention also relates to a stand comprising the mount. The invention further relates to fastening means for an electrical appliance and to an electrical appliance comprising the fastening means. The invention also relates to a toolkit for mounting the electrical appliance, and to a method of mounting the electrical appliance.

### BACKGROUND OF THE INVENTION

Wall-mounts for electrical appliances such as for mounting display devices are known per se and are used for substantially all kinds of display devices. Since the introduction of flat panel display devices such as LCD and/or Plasma display devices, the wall-mounting of the display device has become more popular.

Well known mounts have, for example, a cantilever arm for changing the position of the display device. Such mounts have both been developed for cathode ray tube display devices and for flat panel display devices. Currently, however a new trend for the wall-mounting of flat panel display devices is developing in which the flat panel display device is substantially fixed flat on the wall, preferably at a relatively small distance from the wall which is also known as “floating” of the display device at a distance off the wall. In such a construction the cantilever arm typically is not part of the construction as it would cause the flat panel display device to stand too far off the wall. In such an arrangement the flat panel display device is mounted using a relatively rigid mounting system which substantially fixes the flat panel display device at a certain position on the wall. Such a positioning is especially beneficial when using ambient illumination created by the flat panel display device itself such that the ambient illumination is spread evenly over the remainder of the wall, thus creating the desired ambient effect.

Other wall-mounts or wall-mounting brackets which generate the so called “floating” effect are shown in US2007057133. Such wall-mounting device consist of various parts, some of which need to be mounted on the flat panel display device itself while other parts need to be mounted to the wall.

A disadvantage of these known wall-mounting brackets for flat panel display devices is that they require considerable craftsmanship to mount the flat panel display device correctly.

### SUMMARY OF THE INVENTION

It is an object of the invention to provide a mount for an electrical appliance in which the complexity of the installation of the mount is reduced.

According to a first aspect of the invention the object is achieved with a mount for mounting an electrical appliance as claimed in claim 1. According to a second aspect of the invention, the object is achieved with a stand for supporting an electrical appliance as claimed in claim 8. According to a third aspect of the invention, the object is achieved with fastening means for an electrical appliance as claimed in claim 9. According to a fourth aspect of the invention, the object is achieved with an electrical appliance as claimed in claim 13. According to a fifth aspect of the invention, the object is achieved with a toolkit for mounting an electrical appliance as claimed in claim 14. According to a sixth aspect of the invention, the object is achieved with a method for mounting an electrical appliance on a surface as claimed in claim 15.

The mount according to the first aspect of the invention comprises a base comprising connecting means for connecting the base to a surface or for connecting the base to a stand, the base being configured for distributing a weight of the electrical appliance across a part of the surface or to the stand, the base further comprising mounting means extending from the base,

the mounting means being arranged for engaging with corresponding fastening means of the electrical appliance for mounting the electrical appliance substantially parallel to the base while allowing the electrical appliance to be tilted around a tilting axis substantially perpendicular to the base.

An effect of the mount according to the invention is that the electrical appliance may be tilted around the tilting axis which is substantially perpendicular to the base. Generally, when the mount is fixed to a surface, for example, a wall, the base is arranged substantially parallel to the wall. This allows the electrical appliance to be tilted over the tilting axis which is arranged substantially perpendicular to the wall. Due to the ability of the electrical appliance when mounted on the mount to be tilted around the tilting axis, the fixing of the mount to the surface does not need to be fully level as some none-level fastening of the mount to the surface may be corrected by tilting the electrical appliance. As such, the difficulty of mounting of the electrical appliance to, for example, the surface is substantially reduced.

The mounting means as part of the mount are arranged to cooperate with corresponding fastening means of the electrical appliance. As such, the mounting means and fastening means preferably are separate entities which cooperate with each other to fasten the electrical appliance to the mount. So the mounting means together with the corresponding fastening means form cooperating entities in a comparable manner as a plug and socket.

The electrical appliance, for example, is a display device such as a liquid crystal display device, or an organic light emitting diode display device, or a plasma display device. Alternatively, the electrical appliance may, for example, be an audio/video player, a speaker system, an air-conditioning unit, a computer, a lighting unit or another electrical appliance. Generally, the electrical appliance represents considerable weight and/or value which has to be fastened to the surface or to a stand. This fastening of such relatively high weight or high value electrical appliance preferably must be done secure. As such, the use of a base having connecting means which distributes this weight across a part of the surface is required for safe attachment of the electrical appliance to the wall. Because the popularity of such flat panel display devices is increasing, the mounting of the display devices to the surface is preferably simplified while maintaining the stability and safety. Using the mount according to the invention enables a safe mounting of the electrical appliance while reducing the difficulty of fixing the mount to the surface.

In the known wall-mounting brackets the electrical appliance is relatively rigidly fixed to the wall-mounting brackets. Some tilting may be possible in the known wall-mounting brackets, however, this tilting is generally around an axis arranged substantially parallel to the wall and is, for example, used to tilt the display device downward when the display device is mounted to the wall at considerable height. This tilting is meant to improve the visibility of the display device for a user. However, when applying the known wall-mounting brackets the positioning on the wall of the wall-mounting brackets must be done relatively accurately as even minor adjustments may be relatively difficult, if not impossible. In the mount according to the current invention, the mounting means extends from the base and engages with fastening means of the electrical appliance in a manner such that the electrical appliance may still be tilted around the tilting axis arranged substantially perpendicular to the base. In an embodiment in which the mount is connected to a wall, the tilting axis is arranged substantially perpendicular to the wall. Due to the ability to tilt the electrical appliance after being mounted to the mount, the mount not necessarily has to be level as any un-level-ness may be correct via the tilting of the electrical appliance.

Many different shapes of the mounting means may be applied by a person skilled in the art to obtain a mounted electrical appliance mounted on the mount in which the electrical appliance still is able to tilt around the tilting axis. For example, a short round or nearly round rod extending from the base may be used to engage with a fastening means in the shape of a recess to allow the electrical appliance to be rotatably mounted on the mount. The rod may be exchanged by a round or nearly round tube or by a hook or a hollow pipe or an intersected pipe. The technical requirement of the ability to tilt the electrical appliance after mounting limits the embodiments of the mount and clearly indicates to the skilled person what to built to obtain such tiltable mounting.

The inventors have realized that the mounting of an electrical appliance is relatively difficult. Using the mount according to the current invention allows a tilting of the electrical appliance after it has engaged with the mount to correct for any fastening inaccuracies. This reduces the skills necessary to mount the electrical appliance to a surface considerably.

A further benefit is that the mount according to the invention enables the electrical appliance in the shape of a flat panel display device to be mounted very close to the wall. Especially when using fastening means which constitute a recess in the rear wall of the housing of the electrical appliance, the electrical appliance may be able to be positioned very close to the surface. Known mounts consist of several separate elements which, when put together, place the rear wall of the flat panel display device at a considerable distance from the surface. This is not preferred, as it may result in the mount being visible. Furthermore, such considerable distance takes away part of the advantages of the flat panel display device. Set-makers apply every effort to make the flat panel display device as thin as possible while the known mounts are only able to fasten the flat panel display device at a considerable distance from the wall, causing the flat panel display device to still appear relatively thick. When applying the mount according to the current invention, especially when using the fastening means being a recess in the rear wall of the housing of the flat panel display, the distance between a rear wall of the display device and the surface may be considerably reduced and may, for example, be less than 20 millimeter and even equal or less than 16 millimeters.

An even further benefit is a reduction of costs of the mount. According to the invention, only a base plate and a substantially symmetric extension are required where the extension is able to bear the weight of the electrical appliance such as a display device. The base plate may have substantially any shape and may be manufactured from substantially solid material. This allows a design of the base which is relatively flat while still strong enough to bear the weight of the electrical appliance. As such, the mount may be produced relatively cheap. Furthermore, the fastening means of the electrical appliance may be a recess in the rear wall of the electrical appliance and as such be substantially integrated in the housing of the electrical appliance. No additional mounts or brackets are required which must be fastened to the electrical appliance to be able to mount the electrical appliance. As the current wall-mounts are relatively expensive and the cost of the flat panel display devices is reducing, the wall-mounts contribute considerably to the overall cost of a wall-mounted display device. By reducing the cost of the mount according to the invention by reducing the complexity of the mount and by reducing the difficulty of fastening the mount, considerable cost reduction is obtained when using the mount according to the current invention.

A further benefit of the current mount is that the display device mounted on the mount may be tilted. This tilting may be possible over a range of ±20 degrees around the tilting axis or over a range of ±15 degrees around the tilting axis. This may be beneficial when applying or adding connectors to the electrical appliance. When the electrical appliance is, for example, a display device in which connectors are applied at the bottom of the display device, connecting further appliances to the connectors may be relatively difficult. When the display device may be tilted safely around the tilting axis which is substantially perpendicular to the base, the connection of further appliances to the connectors may be simplified. Currently display devices may also be used to display digital content on a memory stick or USB stick. Also for these applications a port may be positioned at the bottom of the display device. Due to the safe tilting of the display device, the use of these digital ports may be more convenient and safe.

The connecting means for connecting the base to the surface may be by any means of connecting, for example, holes through which screws are applied into the wall for securing the base to the wall. Alternatively, the connecting means to connect the base to the stand may be a welding-strip which may be welded to the stand to secure the base to the stand allowing the display device to be mounted on the stand. Even further alternatively, the connecting means may be some kind of glue, strong enough to hold the relatively high weight of the electrical appliance.

In an embodiment of the mount, the mount further comprises friction means arranged for maintaining a predefined position of the electrical appliance around the tilting axis with respect to the base. A benefit of this embodiment is that the electrical appliance resides relatively rigidly against the friction means providing a solid feel to the mount. Especially when mounting a flat panel display device, the flat panel display device preferably should not immediately start swaying around the tilting axis. By using friction means, any nervous swaying of the electrical appliance is preventing which improves the convenience when using the mount for mounting the electrical appliance to the wall or to the stand.

The friction means may be arranged at a distance from the mounting means and may be produced, for example, as a rim of rubber material or silicon material on the base against which the electrical appliance rests. Due to the contact between the electrical appliance and the friction means, the friction means substantially maintains the current position of the electrical appliance. Furthermore, the friction means require a user to apply some force when tilting the electrical appliance improving the accuracy of the tilting and enabling the electrical appliance to maintain the tilted position as applied by the user. The friction means may alternatively be a friction material arranged around the engaging surface between the extending mounting means and the fastening means. Also in such an embodiment the friction means ensure that the electrical appliance does not nervously start to move which improves the convenience in use. A benefit when using silicon material rather than rubber is that silicon material does not obtain cracks as rubber material typically has over time, and the silicon material generally does not change color so easily as rubber material.

The friction means may also extend at least partially from the base to prevent the electrical appliance to scratch the base while tilting. In such an embodiment, the friction means is a safety precaution for not damaging the electrical appliance.

In an embodiment of the mount, the mounting means extending from the base are configured rotational symmetrical with respect to the tilting axis. A benefit of this embodiment is that it really simplifies the mounting of the mount against, for example, a wall. Due to the rotational symmetry of the mounting means, the mount may basically have any orientation when mounted to the wall or stand, as long as the base is arranged substantially parallel to the wall, the mounting means extend from the wall and are able to engage with the fastening means of the electrical appliance allowing a safe mounting of the electrical appliance. There may be a preferred orientation of the mount on the wall, for example, due to some latches and/or other locking mechanisms which are applied to the mount to prevent the electrical appliance to simply slide off the mounting means. However, also when using such additional latches and/or other locking mechanisms the latches and/or other locking mechanisms may be easily designed such that the mounting of the mount has considerable tolerance related to the orientation of the mount to the wall.

In an embodiment of the mount, the mount further comprises locking means for locking the electrical appliance when engaged on the mounting means. A benefit of this embodiment has already been indicated as being additional safeguard to prevent the electrical appliance to simply slide off the mounting means. Especially for electrical appliances, the costs of such appliances are typically considerably. By adding such locking means, the safe mounting of the electrical appliance is improved while maintaining the ease of applying the mount to the wall.

In an embodiment of the locking means, the locking means is applied using a key for locking and/or unlocking the locking means. Such an embodiment may be beneficially used as theft prevention. Generally the mount is relatively robust and is fixed securely to the wall. When the electrical appliance is mounted on the mount, the fasteners used to fix the mount to the wall will be substantially unreachable. If the locking means would prevent anyone from removing the electrical appliance from the mount, for example, prevent the removal without damaging the electrical appliance severely, the locking means acts as theft prevention. Removing the electrical appliance without key, so using and/or requiring considerable force would damage the electrical appliance and as such make it unfit to sell by the thief. Because also the fasteners are unreachable, the thief may not simply remove the mount from the wall. Removal of the mount while not reaching the fasteners of the mount is relatively unlikely as the fixation of the mount is generally strong and thorough. Due to the robustness of the mount, damaging of the mount also seems relatively unlikely. As such, using a key to lock or unlock the locking means enables the mount to be used as theft prevention.

The key for locking the locking means may be a hardware key fitting in a lock. Alternatively, the key may be a code which may be entered, for example, via a remote control of the electrical appliance, or via a key-pad to release the electrical appliance. In case a wrong code is entered or the lock is broken, an alarm will be triggered.

In an embodiment of the mount, the locking means comprise a removable latch extending from the base for cooperating with a locking recess in the electrical appliance or in the fastening means to continue to allow the tilting of the electrical appliance while locked. A benefit of this embodiment is that it enables the safe tilting of the electrical appliance. As such, when installing the electrical appliance, the electrical appliance may initially be engaged with the mounting means and secured using the latches and/or other locking means. After the electrical appliance has been secured, the correction with respect to the positioning of the electrical appliance by tilting the electrical appliance is possible. As such, the tilting and correct positioning is only done after securing the engaging between the mounting means and the electrical appliance, improving the safety.

This also applies when tilting the electrical appliance for connecting additional connectors as indicated above. Due to the presence of the latches and/or other locking means, the electrical appliance is securely engaged with the mounting means and may safely be tilted to safely connect, reconnect or disconnect additional connectors of the electrical appliance.

A size of the locking recess may be chosen such that the electrical appliance may be tilted over a predefined tilting angle. The tilting angle may, for example, be in a range of ±20 degrees, or even in a range of ±15 degrees.

In an embodiment of the mount, the mount comprises connections for providing power and/or a data-stream to the electrical appliance. As such, the mount may be applied to the wall and all electrical connections may be provided to the mount. Only vary short cables are required to connect the electrical appliance to the mount which reduces the cost of the electrical appliance and which improves the aesthetic appearance of the mounted electrical appliance by avoiding many cables.

Alternatively the mounting means may constitute the connectors to the electrical appliance and may be arranged for providing power and/or a data-stream to the electrical appliance from the mount. In such an arrangement, no cables are required at all and the engaging of the fastening means to the mounting means result in a plug engaging with a socket.

A further benefit of this embodiment is that the electrical appliance may be relatively easily temporarily removed. As the connections for power and/or a data-stream such as a television signal or digital video signal are integrated into the mount, the connector to the mount only needs to be disconnected and the electrical appliance may simply be removed from the mount and stored securely. This may be beneficial when the chances that the electrical appliance may be stolen are relatively high.

In an embodiment of the mount, the connecting means of the base comprises a plurality of holes for allowing fixation means to pass through the holes and be fixed to the surface or the stand for fixating the base to the surface or to the stand. Using a plurality of holes through which the fixation means may be passed to be fixed to the surface allows the base to distribute the weight of the electrical appliance across a part of the surface. Furthermore, the holes preferably have dimensions larger than the fixation means such as to allow some drilling tolerance. Preferably the shape of the fixation means are asymmetric and may even have a shape of a slit to allow considerable drilling tolerance and to allow some movement of the base parallel to the surface.

The holes for fixing the mount to the wall may have a standardized pitch such that the distance between the holes substantially corresponds to the standardized pitch between beams in a wall. This may beneficially be used to ensure that the mount is fixed at a part of the wall such that the fasteners fix the mount at a secure location, for example, in a beam of the wall. This standardized pitch is 350 millimeters.

According to a second aspect of the invention, the object is achieved with a stand comprising the mount. Such a stand may be used to be placed at any location in a room and may even be movable through the room to allow the electrical appliance, for example, a flat panel display to be positioned at substantially any location in the room. Furthermore, the use of a stand prevents the need for securing the mount to a wall of the room.

According to a third aspect of the invention, the object is achieved with fastening means for an electrical appliance, wherein the fastening means are configured for engaging with the mount or with a stand.

In an embodiment of the fastening means, the fastening means are configured to engage to the mounting means by hooking on to the mounting means.

In an embodiment of the fastening means, the fastening means comprise a recess in the electrical appliance. Typically, the recess is arranged at the rear wall of the electrical appliance. A benefit of this embodiment is that the use of a recess in the rear wall of the electrical appliance reduces the effort of a person installing the electrical appliance as the fastening means have already been implemented in the rear wall of the electrical appliance. Furthermore this embodiment saves the cost of a separate fastening means.

A further benefit of this embodiment is that the exact location of the recess may be determined conveniently in the factory for every different model of the electrical appliance, rather than looking for the right location by trial and error. Preferably the recess is positioned near the centre of gravity of the electrical appliance. This may be different for different electrical appliances and may even be different for different models of the same electrical appliance. Additional electronics located inside the casing of the electrical appliance may shift the centre of gravity making the exact location of the recess difficult to predict. By having the recess applied in the factory for every electrical appliance and even for every different model of the electrical appliance, the ease of mounting is further improved.

And an even further benefit of this embodiment, as indicated before, is that the implementation of the recess in the rear wall of the electrical appliance enables the distance between the rear wall of the electrical appliance and the surface or wall on which the electrical appliance is mounted to be minimized.

In an embodiment of the fastening means, the fastening means comprise a slit for allowing the mounting means to slide through the fastening means along a predetermined length in a direction substantially parallel to the base. A benefit of this embodiment is that the slit allows the electrical appliance to be shifted in a direction parallel to the wall, allowing for additional corrections after having mounted the electrical appliance to the mount, and preferably after having secured the electrical appliance to the mount using the latch and/or other locking means. The slit may have a curved shape in which the curve is arranged in operation such that the highest point of the curve is at the highest point at the rear wall of the electrical appliance, located at the centre of gravity of the electrical appliance. Due to this, the natural tendency of the electrical appliance is to level itself. The friction means may be used to mount the electrical appliance in a different manner compared to the natural tendency, to correct, for example, for some local irregularities on the wall.

According to a fourth aspect of the invention, the object is achieved with an electrical appliance comprising the fastening means.

According to a fifth aspect of the invention, the object is achieved with a toolkit for mounting an electrical appliance on a surface, the toolkit comprising:

the mount,

fixation means for fastening the mount to the surface, and

a poster comprising an outline of both the electrical appliance and a required location of the fixation means in relation to the electrical appliance for allowing a user to determine a location of fixation points on the surface for the fixation means in relation to the electrical appliance.

A benefit of this toolkit is that it further simplifies the mounting of the electrical appliance to the surface, for example, to the wall. As the poster comprises an outline of both the electrical appliance and the required location of the fixation means in relation to the electrical appliance, a user may simply stick the poster temporarily on the wall at the location where the electrical appliance should be positioned. The poster may be stuck to the wall using tape. Alternatively, the poster may comprise removable glue, for example at its corners which may be used to temporarily stick the poster on the wall. Using the poster, the user may check whether the chosen position is actually the right position, also when looked at from a distance and/or from other locations of the room. If the proposed location for the electrical appliance indicated with the current poster position is not good or should be improved, the poster may be moved to a different location or the location of the poster may be adapted. As such, the user gets a good indication how the electrical appliance will fit at the chosen position and as such can make a good choice where to mount the electrical appliance. Especially when the electrical appliance is a flat panel display device, the position where the flat panel display device is to be mounted on the wall should be chosen carefully and may depend on how well the flat panel display device can be viewed from different positions of the room. As soon as the user or users agree that the current poster position represents the required position of the electrical appliance, the user simply has to mark the required location of the fixation means, for example, by cutting a hole at the location indicated on the poster and mark the hole on the wall. Alternatively, the poster may already have holes at the required location and the user only needs to mark this position on the wall with a marker. At the marked position, the user may drill holes to fasten the mount against the wall. Any misalignment of the mount will be correctable afterwards by tilting the electrical appliance around the tilting axis. After the mount has been secured to the wall using the locations of the fixation means as indicated by the poster, the fastening means of the electrical appliance, for example, the recess in the rear wall of the flat panel display device may be engaged with the mounting means to mount the flat panel display device to the wall. The location of the flat panel display device, when mounted as described before using the poster, will be substantially equal to the position of the poster and the flat panel display device will substantially cover the same surface of the wall as indicated by the poster.

From the above explanation, it will be clear that the use of the poster together with the mount according to the current invention will further simplify the mounting of the electrical appliance to the surface.

According to a sixth aspect of the invention, the object is achieved with a method of mounting an electrical appliance to a surface via a mount, the method comprising:

determining a location on the surface for mounting the electrical appliance using a poster outlining both the electrical appliance and outlining fixation points indicating a required location of fixation means for fastening the mount on the surface,

fastening the mount at the determined location, and

mounting the electrical appliance via engaging the fastening means with the mounting means of the mount,

adapting a tilt of the electrical appliance by tilting the electrical appliance over the tilting axis.

### BRIEF DESCRIPTION OF THE DRAWINGS

These and other aspects of the invention are apparent from and will be elucidated with reference to the embodiments described hereinafter.

In the drawings:

FIG. 1 shows a schematic plan-view of the mount according to the invention,

FIG. 2 shows a schematic cross-sectional view of an electrical appliance mounted on the wall via the mount according to the invention,

FIG. 3A shows the toolkit for mounting the electrical appliance, and FIGS. 3B and 3C show how the toolkit may be used for mounting the electrical appliance,

FIGS. 4A, 4B and 4C show how the mount may be attached to the wall and how the electrical appliance may be first fixed to the mount and subsequently leveled by tilting the electrical appliance around the tilting axis, and

FIG. 5 shows different embodiments of the mount according to the invention.

The Figures are purely diagrammatic and not drawn to scale. Particularly for clarity, some dimensions are exaggerated strongly. Similar components in the Figures are denoted by the same reference numerals as much as possible.

### DETAILED DESCRIPTION OF EMBODIMENTS

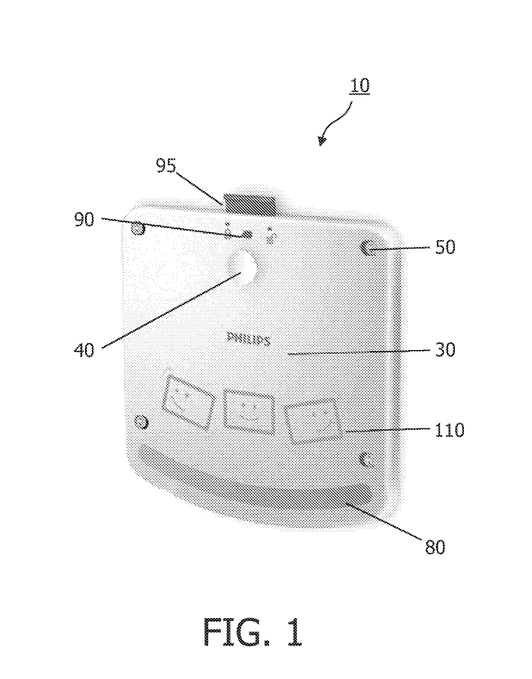

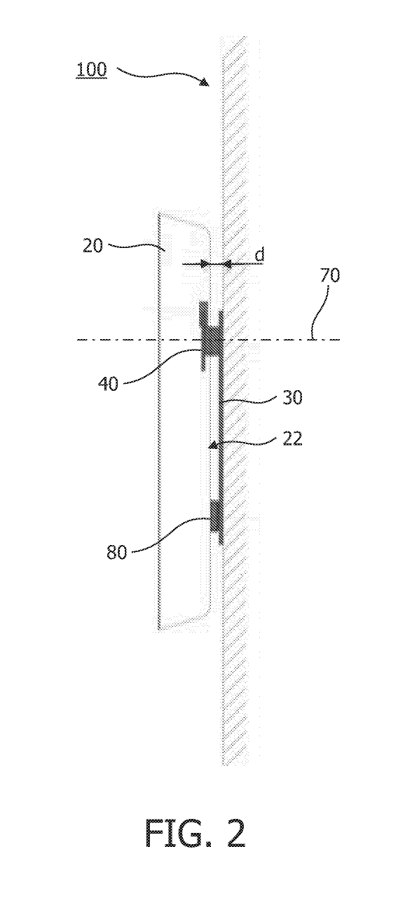

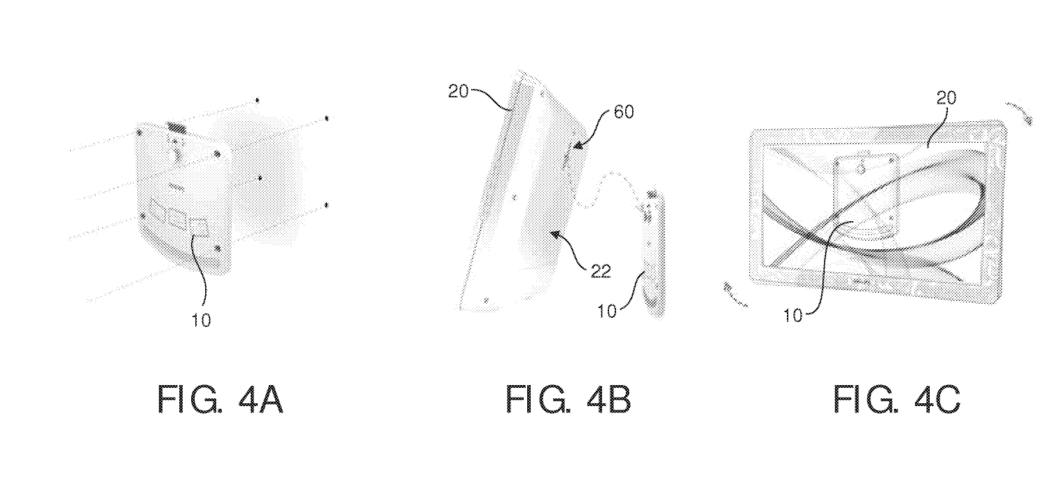

FIG. 1 shows a schematic plan-view of the mount 10 according to the invention. The mount 10 as shown in FIG. 1 comprises a base 30 which comprises connecting means 50 in the form of holes through which fasteners (not shown) may be applied, for example, to fix the mount 10 to a wall 100 (see FIG. 2). The base 30 when mounted to the surface 100 of the wall 100 distributes a weight of the electrical appliance 20 (see FIG. 2) across a part of the surface 100 or to the stand. The weight of the electrical appliance 20 typically is considerably, especially when the electrical appliance 20 is a flat panel display device 20 or a plasma display device 20. The base 30 further comprising mounting means 40 which extend from the base 30. The mounting means 40 are shown as a kind of knob 40 which protrudes from the base 30 and which is strong enough to carry the weight of the electrical appliance 20 which is mounted on the mount 10. The mounting means 40 is arranged to engage with corresponding fastening means 60 (see FIG. 4C) of the electrical appliance 20 such that the electrical appliance 20 is securely mounted on the mount 10 and in which the rear wall 22 (see FIG. 2) of the electrical appliance 20 is arranged substantially parallel to the base 30. The engagement of the fastening means 60 to the mounting means 40 is such that the electrical appliance 20 is allowed to be tilted around a tilting axis 70 (see FIG. 2) which is arranged substantially perpendicular to the base 30.

Due to the fact that the electrical appliance 20 when mounted on the mount 10 can be tilted around the tilting axis 70, the fixing of the mount 10 to the surface 100 does not need to be fully level. Any error related to the leveling of the mount 10 may be easily corrected by tilting the electrical appliance 20 after it has been mounted on the mount 10. As such, the difficulty of mounting of the electrical appliance 10 to, for example, the surface 100 is substantially reduced.

The mounting means 40 which extend from the base 30 are configured substantially rotational symmetrical with respect to the tilting axis 70. This allows the mounting of the electrical appliance 20 to be substantially not influenced by the orientation of the mount 10. As such, the mount 10 may be arranged in any orientation rotated around the tilting axis 70 and still, the electrical appliance 20 may be mounted on the mount 10. As long as the base 30 is arranged substantially parallel to the wall 100, and as long as the mounting means 40 extend from the base 40 and as such from the wall 100 the fastening means are able to engage with the mounting means 40 allowing a safe mounting of the electrical appliance 20. A limitation to this orientation of the mount 10 may be presented when the locking means 90 may be present on the mount 10. As the locking means 90 may, for example, be designed such that they need to engage with a further recess (not shown) at the fastening means 60 or at the rear wall 22 of the electrical appliance 20, the arrangement of the further recess may limit the orientation of the mount 10 with respect to the preferred orientation of the electrical appliance 20 when mounted on the mount 10.

The electrical appliance 20, for example, is a display device 20 such as a liquid crystal display device 20, or an organic light emitting diode display device 20, or a plasma display device 20. Alternatively, the electrical appliance 20 may, for example, be an audio/video player (not shown), a speaker system (not shown), an air-conditioning unit (not shown), a computer (not shown), a lighting unit (not shown) or another electrical appliance 20. Generally, the electrical appliance 20 which has to be fastened to the surface 100 or to a stand (not shown) represents considerable weight and/or value. This fastening of such relatively high weight and/or high value electrical appliance 20 preferably must be done secure. As such, the use of the base 30 having connecting means 50 which distributes this weight across a part of the surface 100 is required for safe attachment of the electrical appliance 20 to the wall 100.

In the embodiment of the mount 10 as shown in FIG. 1, the mount 10 further comprises friction means 80. These friction means 80 may be used to cause the electrical appliance 20 to reside relatively rigidly against the friction means 80 and as such provide a solid feel to the mounting of the electrical appliance 20. The friction means 80 may, for example, be arranged at a distance from the mounting means 40 as is shown in FIG. 1. Alternatively, the friction means 80 may be part of the mounting means 40 (not shown), for example, arranged around the extending part of the extension means 40 as a rim of friction material, for example, rubber or silicon. The arrangement of the friction means 80 may be such that the electrical appliance 20 when mounted on the mount 10 rests against the friction means 80. Due to the contact between the electrical appliance 20 and the friction means 80, the friction means 80 cause the electrical appliance 20 to substantially maintain its current position.

The friction means 80 may also extend at least partially from the base 30 (as is shown in FIG. 2) to prevent the electrical appliance 20 to scratch the base 30 when adjusting and/or leveling the electrical appliance 20 when mounted on the mount 10. In such an embodiment, the friction means 80 may be a safety precaution for not damaging the electrical appliance 20.

The mount 10 as shown in FIG. 1 further comprises locking means 90 for locking the electrical appliance 20 when the fastening means 60 are engaged on the mounting means 40. The locking means 90 may, for example, be a removable latch 90 which may snap into a locked position and which may be released using a lever 95. A benefit of the locking means 90 is that they prevent an additional safeguard to prevent that the electrical appliance 20 may simply slide off the mounting means 20. Especially for electrical appliances 20, the cost of such electrical appliance 20 typically is considerable. By adding the locking means 90, the safe mounting of the electrical appliance 20 is improved while maintaining the ease of applying the mount 10 to the wall 100.

The locking means 90 may be configured such that a key (not shown) is required for locking and/or unlocking the locking means 90. Such an embodiment may be beneficially used as theft prevention. The key may be a hardware key fitting in a lock. Alternatively, the key may be a code which should be entered, for example, via a remote control of the electrical appliance 20 to release the electrical appliance 20. In case a wrong code is entered, an alarm may be triggered.

The mount 10 may comprise connections (not shown) for providing, for example, power and/or a data-stream to the electrical appliance 20. As such, the mount 10 may be applied to the wall 100 and all electrical connections may be provided in the mount 10. Only vary short cables (not shown) are required to connect the electrical appliance 20 to the mount 10 which reduces the cost of the electrical appliance 20 and which improves the aesthetic appearance of the mounted electrical appliance 20 by avoiding many cables.

The mount 10 may also be connected to a stand (not shown). A stand is generally arranged for being connected to the electrical appliance 20 such that the electrical appliance 20 may be placed on a table (not shown) or on the floor. Such stands are relatively common and well known in the art. The benefit of the stand comprising the mount 10 according to the invention is that it enables to adjust the orientation of the electrical appliance 20 also when the stand may rest on an uneven surface. Whether this would be a safe place to put the electrical appliance 20 is no discussion in this respect, but after putting the electrical appliance 20 on the uneven surface, the electrical appliance 20 may be leveled by tilting the electrical appliance 20 around the tilting axis 70.

FIG. 2 shows a schematic cross-sectional view of the electrical appliance 20 when mounted on the wall 100 via the mount 10 according to the invention. In the embodiment as shown in FIG. 2, the fastening means 60 are constituted by a recess 60 at the rear wall 22 of the electrical appliance 20. In such an embodiment, the recess 60 may be chosen such that the mounting means 40 fit into the recess 60 substantially fully allowing the electrical appliance 20 to be mounted very close to the wall 100. Known mounts consist of several separate elements which, when put together, place the electrical appliance 20 in the shape of a flat panel display device 20 at a considerable distance from the surface 100. This is not preferred, as it may result in the mount 10 being visible. Furthermore, such considerable distance takes away part of the advantages of the flat panel display device 20. Set-makers apply every effort to make the flat panel display device 20 as thin as possible. Using the known mounts would not provide the full benefit of this effort as the known mounts would fasten the flat panel display device 20 at a considerable distance from the wall 100, causing the display to still appear relatively thick. When applying the mount 10 according to the current invention, especially when using the fastening means 60 being a recess 60 in the rear wall 22 of the housing of the flat panel display device 20, the distance d between a rear wall 22 of the flat panel display device 20 and the wall 100 may be considerably reduced and may be less than 20 millimeters and even equal or less than 16 millimeters.

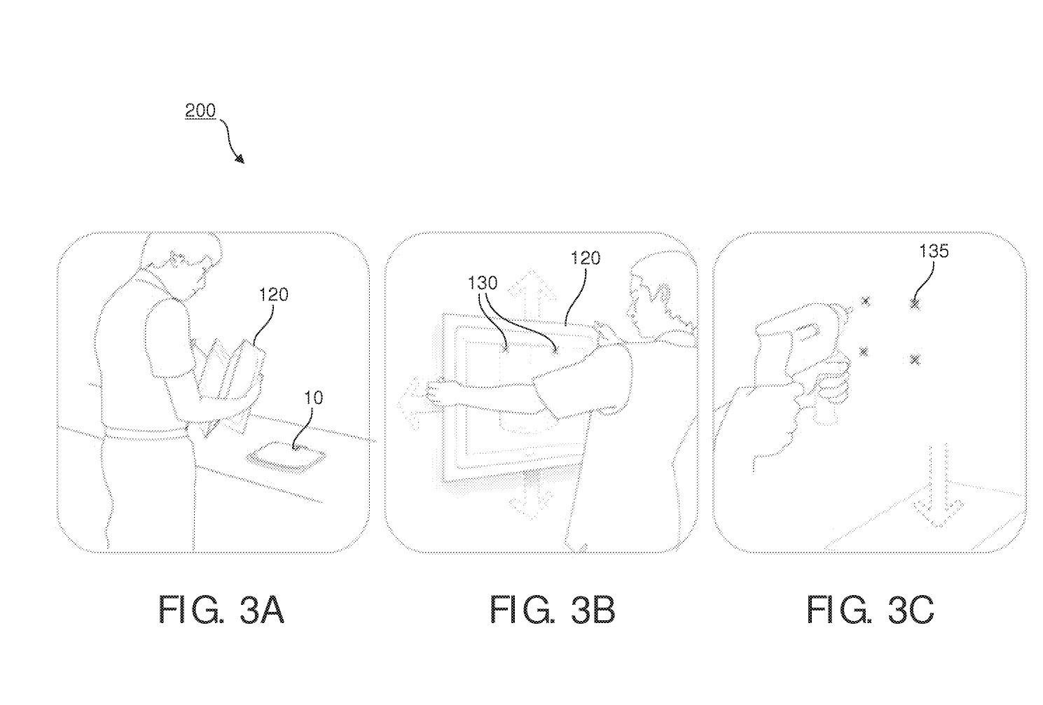

FIG. 3A shows the toolkit 200 for mounting the electrical appliance 20. The toolkit comprises the mount 10, fixation means (not shown) or fasteners such as screw and nuts and bolts. The toolkit further comprises a poster 120. The poster 120 comprises an outline of both the electrical appliance 20 and a required location of the fixation means in relation to the electrical appliance 20. This outline allows a user to determine a location of fixation points 130 on the surface 100 for the fixation means in relation to the electrical appliance 20. Preferably the outline of the electrical appliance 20 on the poster 120 is a full scale outline of the electrical appliance 20 such that the full scale outline may be used to provide an indication to a user how the electrical appliance 20 would fit at the chosen location at the wall 100. A benefit of this toolkit 100 is that it further simplifies the mounting of the electrical appliance 20 to the surface 100, for example, to the wall 100. As the poster comprises the full scale outline of both the electrical appliance 20 and the required location 130 of the fixation means in relation to the electrical appliance 20, the user may simply stick the poster 120 temporarily to the wall 100 at the location where the electrical appliance 20 should be positioned. The poster 120 may be stuck on the wall 100 using, for example, tape. Alternatively, the poster 120 may comprise removable glue, for example at its corners which may be used to temporarily stick the poster 120 to the wall 100. Using the poster 120, the user may check whether the chosen position is actually the right position, also when looked at from a distance and/or from other locations of the room. If the proposed location for the electrical appliance 20 indicated with the current poster 120 position is not good or should be improved, the poster 120 may be moved to a different location or the location of the poster 120 may be adapted. As such, the user gets a good indication how the electrical appliance 20 will fit at the chosen position and as such can make a good choice where to mount the electrical appliance 20 before drilling holes in the wall 100. Especially when the electrical appliance 20 is a flat panel display device 20, the position where the flat panel display device 20 is to be mounted on the wall 100 should be chosen carefully and may depend on how well the flat panel display device 20 can be viewed from different positions of the room. As soon as the user or users agree that the current poster 120 position represents the required position of the electrical appliance 20, the user simply has to mark the required location 130 of the fixation means, for example, by cutting a hole 130 at the location indicated on the poster 120 and mark the location 135 on the wall. Alternatively, the poster 120 may already have holes 130 at the required location 130 and the user only needs to mark 135 this position on the wall with a marker. At the marked position 135, the user may drill holes and fasten the mount 10 against the wall. Any misalignment of the mount 10 will be correctable afterwards by tilting the electrical appliance 20 around the tilting axis 70 (see FIG. 2). After the mount 10 has been secured to the wall 100 using the locations 130 of the fixation means as indicated by the poster 120, the fastening means 60 of the electrical appliance 20, for example, the recess 20 in the rear wall 22 of the flat panel display device 20 may be engaged with the mounting means 40 to mount the flat panel display device 20 to the wall 100. The location of the flat panel display device 20, when mounted as described before using the poster 120, will be substantially equal to the position of the poster 120, and the flat panel display device 20 will substantially cover the same part of the wall 100 as indicated by the poster 120.

FIGS. 3B and 3C show how the toolkit 200 may be used for mounting the electrical appliance 20. In FIG. 3B the exact position of the electrical appliance 20 is chosen by holding the poster 120 at a location against the wall 100 where the electrical appliance 20 may be mounted. Subsequently, the user may use the outlined fixation points 130 to provide markers 135 on the wall 100 as indicated in FIG. 3C. A drill may be used to generate holes at the location of the markers 135 and fasteners may be used to fix the mount 10 to the wall 100 (see also FIG. 4A).

FIGS. 4A, 4B and 4C show how the mount 10 may be attached to the wall 100 and how the electrical appliance 20 may be first fixed to the mount 10 (FIG. 4B), and subsequently leveled (FIG. 4C) by tilting the electrical appliance 20 around the tilting axis 70. The fastening means 60 are preferably constituted by the recess 60 arranged at the rear wall 22 of the electrical appliance 20. When the recess 60 is used as fastening means 60, the electrical appliance 20 may be mounted very close to the wall 100 and the exact location of the fastening means 60 to allow the fastening means 60 to be arranged substantially at a centre of gravity is already determined by the set-builder in the factory. Furthermore this embodiment reduces the cost as there is no need for a separate fastening means 60.

Alternatively, the fastening means 60 may be separate fastening means 60 which may be applied separately to the rear wall 22 of the electrical appliance 20 after which the fastening means 60 may be used to mount the electrical appliance 20 by engaging the fastening means 60 to the mounting means 40. Such separate fastening means 60 may be beneficial when using the mount 10 also for electrical appliances 20 which do not have the recess 60 applied at the right location at the rear wall 22 of the electrical appliance 20.

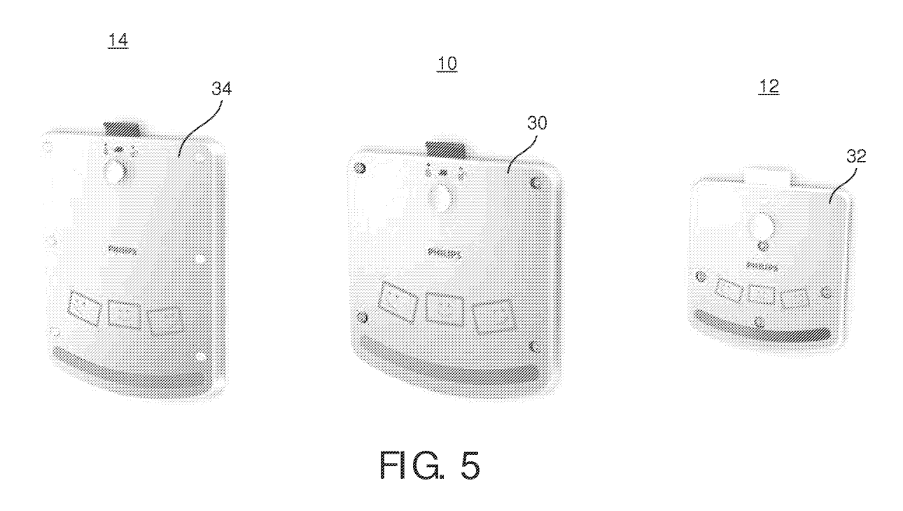

FIG. 5 shows different embodiments of the mount 10, 12, 14 according to the invention. The difference between the different embodiments of the mount 10, 12, 14 as shown in FIG. 5 is that the size of the base 30, 32, 34 is different and the number of connecting means 50 for connecting the base 30, 32, 34 to the wall is different. The mount 10 as indicated in the centre of FIG. 5, would, for example, be required for mounting a 32 inch flat panel display device 20 to the wall 100. When there may be need for mounting a larger flat panel display device 20, for example, a 42 inch flat panel display device 20, the larger mount 12 may be required having increased number of connecting means 50. Such a larger flat panel display device 20 typically also is heavier, thus requiring more weight to be distributed across a part of the surface 100 via more fasteners through the connecting means 50. However, when only a 22 inch flat panel display device 20 must be mounted on the wall 100, a smaller mount 12 may be sufficient. Each of the mounts 10, 12, 14 comprise the mounting means 40 as an extension extending from the base 30, 32, 34, and each of the mounts 10, 12, 14 comprise friction means 80 for maintaining the electrical appliance 20 at a tilted position. Furthermore, each of the mounts 10, 12, 14 comprises locking means 90 for securing the electrical appliance 20 when mounted on the mount 10, 12, 14.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. Mount (10; 12; 14) for mounting an electrical appliance (20), the mount (10; 12; 14) comprising a base (30; 32; 34) comprising connecting means (50) for connecting the base (30; 32; 34) to a surface (100) or for connecting the base (30; 32; 34) to a stand, the base (30; 32; 34) being configured for distributing a weight of the electrical appliance (20) across a part of the surface (100) or to the stand, the base (30; 32; 34) further comprising mounting means (40) extending from the base (30; 32; 34),
the mounting means (40) being arranged for engaging with corresponding fastening means (60) of the electrical appliance (20) for mounting the electrical appliance (20) substantially parallel to the base (30; 32; 34) while allowing the electrical appliance (20) to be tilted around a tilting axis (70) being substantially perpendicular to the base (30; 32; 34).

2. Mount (10; 12; 14) as claimed in claim 1, wherein the mount (10; 12; 14) further comprises friction means (80) arranged for maintaining a predefined position of the electrical appliance (20) around the tilting axis (70) with respect to the base (30; 32; 34).

3. Mount (10; 12; 14) as claimed in claim 1, wherein the mounting means (40) extending from the base (30; 32; 34) are configured rotational symmetrical with respect to the tilting axis (70).

4. Mount (10; 12; 14) as claimed in claim 1, wherein the mount (10; 12; 14) further comprises locking means (90) for locking the electrical appliance (20) when engaged on the mounting means (40).

5. Mount (10; 12; 14) as claimed in claim 4, wherein the locking means (90) comprise a removable latch (90) extending from the base (30; 32; 34) for cooperating with a locking recess in the electrical appliance (20) or in the fastening means (60) to continue to allow the tilting of the electrical appliance (20) while locked.

6. Mount (10; 12; 14) as claimed in claim 1, wherein the mount (10; 12; 14) comprises connections for providing power and/or a data-stream to the electrical appliance (20).

7. Mount (10; 12; 14) as claimed in claim 1, wherein the connecting means (50) of the base (30; 32; 34) comprises a plurality of holes (50) for allowing fixation means to pass through the holes (50) and be fixed to the surface (100) or the stand for fixating the base (30) to the surface (100) or to the stand.

8. Stand for supporting an electrical appliance (20), the stand comprising the mount (10; 12; 14) as claimed in claim 1.

9. Fastening means (60) for an electrical appliance (20), wherein the fastening means (60) are configured for engaging with the mount (10; 12; 14) as claimed in claim 1.

10. Fastening means (60) as claimed in claim 9, wherein the fastening means (60) are configured to engage to the mounting means (40) by hooking on to the mounting means (40).

11. Fastening means (60) as claimed in claim 9, wherein the fastening means (60) comprise a recess (60) in the electrical appliance (20).

12. Fastening means (60) as claimed in claim 9, wherein the fastening means (60) comprise a slit for allowing the mounting means (40) to slide through the fastening means (60) along a predetermined length in a direction substantially parallel to the base (30; 32; 34).

13. Electrical appliance (20) comprising the fastening means (60) as claimed in claim 9.

14. Toolkit (200) for mounting an electrical appliance (20) on a surface (100), the toolkit (200) comprising:
the mount (10; 12; 14) as claimed in claim 1,
fixation means for fastening the mount (10; 12; 14) to the surface (100), and
a poster (120) comprising an outline of both the appliance (20) and a required location of the fixation means in relation to the appliance (20) for allowing a user to determine a location of fixation points (130) on the surface (100) for the fixation means in relation to the appliance (20).

15. Method of mounting an electrical appliance (20) to a surface (100) via a mount (10; 12; 14) as claimed in claim 1, the method comprising:
determining a location on the surface (100) for mounting the electrical appliance (20) using a poster (120) outlining both the electrical appliance (20) and outlining fixation points (130) indicating a required location of fixation means for fastening the mount (10; 12; 14) on the surface (100),
fastening the mount (10; 12; 14) at the determined location, and
mounting the electrical appliance (20) via engaging the fastening means (60) with the mounting means (40) of the mount (10; 12; 14),
adapting a tilt of the electrical appliance (20) by tilting the electrical appliance (20) over the tilting axis (70).
